(19) United States
(12) Patent Application Publication
(10) Pub. No.: US 2014/0015499 A1
(43) Pub. Date: Jan. 16, 2014

(54) VOLTAGE RESOLUTION ADJUSTMENT SYSTEM AND METHOD

(71) Applicant: ASKEY COMPUTER CORP., NEW TAIPEI CITY (TW)

(72) Inventors: CHIH-SUNG LAI, NEW TAIPEI CITY (TW); CHENG-HUNG WU, NEW TAIPEI CITY (TW)

(73) Assignee: ASKEY COMPUTER CORP., NEW TAIPEI CITY (TW)

(21) Appl. No.: 13/672,736

(22) Filed: Nov. 9, 2012

(30) Foreign Application Priority Data
Jul. 13, 2012 (TW) 101125290

(51) Int. Cl. G05F 1/625

(52) U.S. Cl. CPC G05F 1/625
USPC 323/234

(57) ABSTRACT

A voltage resolution adjustment system and method increase voltage resolution of an output voltage of a processor from a first voltage resolution to a second voltage resolution. The system includes a processing module, a voltage-dividing module, and an amplifying unit. The processing module generates a first voltage of a first voltage resolution. The voltage-dividing module increases the first voltage of the first voltage resolution to a second voltage of a second voltage resolution. The amplifying unit increases the second voltage to a third voltage (i.e., the output voltage). After comparing the third voltage and the first voltage and detecting a voltage difference therebetween, the processing module generates a control signal for changing a voltage partitioning ratio of the voltage-dividing module to render the third voltage and the first voltage equal, wherein the third voltage is of the second voltage resolution.

### CROSS-REFERENCE TO RELATED APPLICATION

This non-provisional application claims priority under 35 U.S.C. §119(a) on Patent Application No(s).101125290 filed in Taiwan, R.O.C. on Jul. 13, 2012, the entire contents of which are hereby incorporated by reference.

### FIELD OF TECHNOLOGY

The present invention relates to voltage resolution adjustment systems and methods, and more particularly, to a system and method of increasing a voltage resolution of an output voltage of a processor from a low voltage resolution to a high voltage resolution.

### BACKGROUND

With electronic manufacturing becoming more sophisticated, there is an increasing demand for the precision of electronic apparatus for use in examining electronic products. Take a power supply as an example, to render it easy to measure the parameters of the electronic products in a precise and stable manner, it is necessary that the voltage resolution of an output voltage of the power supply has to be of high precision. For instance, the voltage resolution has to be lower than 0.1 mV in order for the output voltage to be precise to the first decimal place when measured in mV.

Unless otherwise equipped with pricy electronic components of a high voltage resolution, conventional power supplies are unlikely to achieve a voltage resolution of lower than 1 mV, let alone achieving a voltage resolution of lower than 0.1 mV. Hence, the voltage resolution of the output voltage of conventional power supplies fails to meet the requirement for high-precision voltage expected of conventional electronic products.

In view of the aforesaid drawback of the prior art, power supply manufacturers usually devise pricy processors having a relatively large number of bits (such as a 16-bit digital-to-analog converter chip, as voltage resolution correlates with number of bits) during a power supply circuit design stage with a view to achieving a voltage resolution of 0.1 mV. For example, Agilent produces B2901A power supply which has voltage resolution of 0.1 mV.

Although the above prior art readily achieves outputting an output voltage of a high voltage resolution, a tremendously high cost is incurred in providing a great number of the aforesaid high voltage resolution power supplies on a production line, not to mention that chances are, in the face of an increase in high voltage resolution, the original high voltage resolution power supplies cannot be directly upgraded.

Accordingly, it is imperative to generate an output voltage of a high voltage resolution at a relatively low cost or increase the output voltage from a low voltage resolution to a high voltage resolution easily.

### SUMMARY

It is an objective of the present invention to provide a voltage resolution adjustment system for increasing an output voltage from a low voltage resolution to a high voltage resolution.

In order to achieve the above and other objectives, the present invention provides a voltage resolution adjustment system for increasing a voltage resolution of a first voltage from a first voltage resolution to a second voltage resolution. The first voltage resolution correlates with a quantity of a plurality of first bits. The voltage resolution adjustment system comprises a processing module, a voltage-dividing module, and an amplifying unit. The processing module receives the first bits and outputting the first voltage and a control signal based on the first bits. The voltage-dividing module has a voltage output end and a voltage input end and is connected to the processing module via the voltage input end and adapted to configure a voltage partitioning ratio between the voltage output end and the voltage input end, thereby changing the first voltage to a second voltage of a second voltage resolution, wherein the voltage partitioning ratio varies with a voltage level of the control signal. The amplifying unit has an amplification output end and an amplification input end. The amplifying unit is connected to an output end of the voltage-dividing module via the amplification input end, connected to the processing module via the amplification output end, and characterized by a voltage amplification ratio between the amplification output end and the amplification input end, so as to increase the second voltage to a third voltage by amplification. Given a voltage difference between the third voltage and the first voltage, the processing module sends the control signal having a voltage value for adjusting the voltage partitioning ratio and thereby making the third voltage equal to the first voltage. The third voltage has the second voltage resolution.

In another embodiment, the processing module and the voltage-dividing unit each have an inter-integrated circuit bus (I²C), such that the processing module and the voltage-dividing unit send the control signal via the inter-integrated circuit bus.

In yet another embodiment, the voltage-dividing module comprises an invariable voltage-dividing unit and an adjustable voltage-dividing unit, wherein the invariable voltage-dividing unit and the adjustable voltage-dividing unit are connected in series.

In order to achieve the above and other objectives, the present invention further provides a voltage resolution adjustment method, comprising the steps of: (a) generating a plurality of first bits for generating a first voltage of a first voltage resolution; (b) configuring a voltage partitioning ratio for changing the first voltage to a second voltage of a second voltage resolution; (c) amplifying the second voltage so as to change the second voltage to a third voltage of the second voltage resolution; and (d) comparing the first voltage and the third voltage to find a voltage difference therebetween and changing the voltage partitioning ratio based on the voltage difference to make the third voltage equal to the first voltage.

In another embodiment, the voltage partitioning ratio further comprises a constant voltage partitioning ratio and an adjustable voltage partitioning ratio, the constant voltage partitioning ratio being configured according to a proportion between impedance values, the second voltage resolution depending on the impedance values, wherein a ratio of the first voltage to the second voltage is determined according to the constant voltage partitioning ratio and the adjustable voltage partitioning ratio.

Compared with the prior art, the present invention provides a voltage resolution adjustment system and method which, coupled with a system based on a combination of software and hardware, increase a low voltage resolution of an output voltage characterized by a low voltage resolution and generated by hardware (such as a chip of a digital-to-analog converter (DAC)) to a high voltage resolution. Hence, the voltage resolution adjustment system and method of the present invention are effective in producing a voltage output system of a high voltage resolution with cheap hardware of low voltage resolution. The system not only cuts hardware-based production costs, but also generates an output voltage of a specific high voltage resolution (such as 0.1 mV) precisely and in real time.

### BRIEF DESCRIPTION OF THE DRAWINGS

Objectives, features, and advantages of the present invention are hereunder illustrated with specific embodiments in conjunction with the accompanying drawings, in which:

FIG. 1 is a circuit diagram of a voltage resolution adjustment system according to an embodiment of the present invention; and

FIG. 2 is a flow chart of a voltage resolution adjustment method according to an embodiment of the present invention.

### DETAILED DESCRIPTION

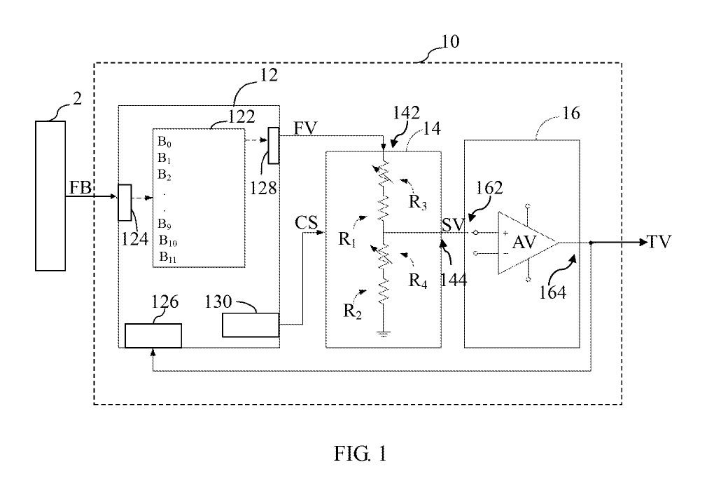

Referring to FIG. 1, there is shown a circuit diagram of a voltage resolution adjustment system 10 according to an embodiment of the present invention. As shown in FIG. 1, the voltage resolution adjustment system 10 receives a plurality of first bits FB generated from a computer servo end 2. This embodiment is exemplified by the 12-bit computer servo end 2. The first bits FB are transmitted from the computer servo end 2 to input ports B₀˜B₁₁. The first bits FB denote a first voltage FV of a first voltage resolution.

For example, the 12-bit computer servo end 2 has a maximum output voltage of 3.3V, and thus the output voltage of each bit of the computer servo end 2 is 0.8 mV (by dividing 3.3V by 2¹²). With the voltage resolution adjustment system 10 of the present invention, the output voltage of the first voltage resolution based on the first bits FB (12 bits) is increased to an output voltage of a second voltage resolution based on a plurality of second bits SB (15 bits). Take the aforesaid maximum output voltage of 3.3V as an example, the output voltage of each bit of the 15-bit computer servo end is 0.1 mV. Hence, 15 bits surpasses 12 bits in voltage resolution per bit.

The voltage resolution adjustment system 10 comprises a processing module 12, a voltage-dividing module 14, and an amplifying unit 16.

In this embodiment, the processing module 12 comprises a control unit 122, a first input unit 124, a second input unit 126, a first output unit 128, and a second output unit 130.

The first input unit 124 is connected to the computer servo end 2.

The control unit 122 is connected to the first input unit 124. The control unit 122 generates the first voltage FV from the first bits FB received from the first input unit 124. The control unit 122 comprises a plurality of input ports B₀˜B₁₁ corresponding in position to the first bits FB, respectively. For example, the control unit 122 is a digital-to-analog converter. This embodiment is exemplified by the control unit 122 which has 12 input ports.

The first output unit 128 outputs the first voltage FV of the first voltage resolution.

For example, the computer servo end 2 (12 bits) generates the first bits FB, wherein the first bits FB are expressed as 000000000001. The control unit 122 receives the first bits FB from the first input unit 124 via the input ports B₀˜B₁₁. Hence, the control unit 122 turns the first bits FB into the first voltage FV and outputs the first voltage FV from the first output unit 128. That is to say, the first voltage FV is generated as a result of a conversion process performed by the control unit 122 on the first bits FB. Hence, the first voltage FV features the first voltage resolution. In this embodiment, 12 said first bits FB are provided, for an exemplary purpose, and each of the first bits FB denotes 0.8 mV. Hence, if the first bits FB switches from 000000000000 to 111111111111, the control unit 122 will output the first voltage FV, and the voltage range of the first voltage FV increases from 0V to 3.3V.

The second input unit 126 and the second output unit 130 are described in detail below.

The voltage-dividing module 14 has a voltage input end 142 and a voltage output end 144. The relationship of the voltage input end 142 and the voltage output end 144 is defined with a voltage partitioning ratio. The voltage-dividing module 14 is connected to the first output unit 128 of the processing module 12 via the voltage input end 142.

The first voltage FV applies to the voltage input end 142 of the voltage-dividing module 14. A second voltage SV is generated from the voltage output end 144 of the voltage-dividing module 14. Furthermore, the second voltage SV has a second voltage resolution.

A point to note is that the voltage partitioning ratio provided by the voltage-dividing module 14 varies with the voltage of a control signal CS generated from the second output unit 130 of the control unit 122.

In this embodiment, the voltage-dividing module 14 is exemplified by an invariable voltage-dividing unit and an adjustable voltage-dividing unit, respectively.

The voltage-dividing module 14 determines the second voltage resolution of the first voltage FV when implemented in the form of the invariable voltage-dividing unit.

For example, the invariable voltage-dividing unit comprises two fixed resistors R₁, R₂, and the second voltage resolution of the first voltage FV is determined according to the resistance of the fixed resistors R₁, R₂. For example, if the fixed resistors R₁, R₂ are of 30 ohm approximately, the second voltage resolution can be increased to the next level of voltage resolution (that is to say, the next voltage resolution level is denoted by a bit.) Hence, the first voltage FV has one bit more than the first bits FB does.

The adjustable voltage-dividing unit changes the voltage partitioning ratio of the second voltage SV to the first voltage FV in the voltage-dividing module 14 according to the control signal CS.

For example, the adjustable voltage-dividing unit comprises two variable resistors R₃, R₄, and the variable resistors R₃, R₄ are of thousand ohms of resistance for allowing the voltage-dividing module 14 to perform a voltage division process on the first voltage FV according to the voltage partitioning ratio (i.e., (R₂+R₄)/(R₁+R₂+R₃+R₄)) and output the second voltage SV, wherein the mathematic relation between the second voltage SV and the first voltage FV is as follows:

SV=FV*(R₂+R₄)/(R₁+R₂+R₃+R₄)

The amplifying unit 16 has an amplification input end 162 and an amplification output end 164 The relationship of the amplification output end 164 and the amplification input end 162 is defined with a voltage amplification ratio AV. The amplifying unit 16 is connected to the voltage output end 144 of the voltage-dividing module 14 via the amplification input end 162. The amplification output end 164 is connected to the second input unit 126 of the processing module 12.

The amplifying unit 16 receives the second voltage SV and increases the second voltage SV to a third voltage TV (third voltage) according to the voltage amplification ratio AV. The mathematic relation between the third voltage TV and the second voltage SV is as follows:

TV=SV*AV

The third voltage TV is output from the amplification output end 164 and is applied to the second input unit 126 of the processing module 12. For example, the processing module 12 determine, using a built-in algorithm, whether the third voltage TV and the first voltage FV are equal or different in voltage level. For example, if it is determined that the third voltage TV differs from the first voltage FV in voltage level, the control unit 122 of the processing module 12 will generate the control signal CS for adjusting the adjustable voltage-dividing unit R₃, R₄. The control signal CS not only serves to adjust the resistance of the adjustable voltage-dividing unit R₃, R₄ and thereby change the second voltage SV, but also causes the third voltage TV to vary with the second voltage SV, thereby making the third voltage TV and the first voltage FV equal in voltage level.

In the above embodiments, the values of all the parameters mentioned can be adjusted according to the required voltage resolution. The system increases a low voltage resolution (i.e., the first voltage resolution which correlates with the first bits FB) of an output voltage to a high voltage resolution (i.e., the second voltage resolution which correlates with the second bits SB). The number of the first bits FB is less than the number of the second bits SB.

In yet another embodiment, both the processing module 12 and the voltage-dividing unit 14 each have an inter-integrated circuit bus (I²C, not shown), such that the processing module 12 and the voltage-dividing unit 14 can transmit the control signal CS via the inter-integrated circuit bus.

In this embodiment, a user specifies a voltage at the computer servo end 2 and performs an encoding process on the voltage to thereby enable the processing module 12 to provide the first voltage FV having the first voltage resolution according to the first bits FB. Assuming that the maximum voltage level is 3.3V and the computer servo end 2 operates on a 12-bit basis, the voltage level (such as 3.3V) can be divided into 4096 levels (i.e., 2 to the power of 12, or 2¹² for short), and in consequence each level can be expressed as 0.8 mV.

Furthermore, to ensure that the processing module 12 will output the first voltage FV having the first voltage resolution precisely, the computer servo end 2 is calibrated beforehand. The calibration comprises the steps of: sending the first bits FB from the computer servo end 2; receiving the first voltage FV by the processing module 12; and performing calibration-oriented computation with the least squares method and linear equations at the computer servo end 2 to thereby obtain a calibration parameter value for ensuring that the control unit 122 of the processing module 12 can output the first voltage FV of high precision.

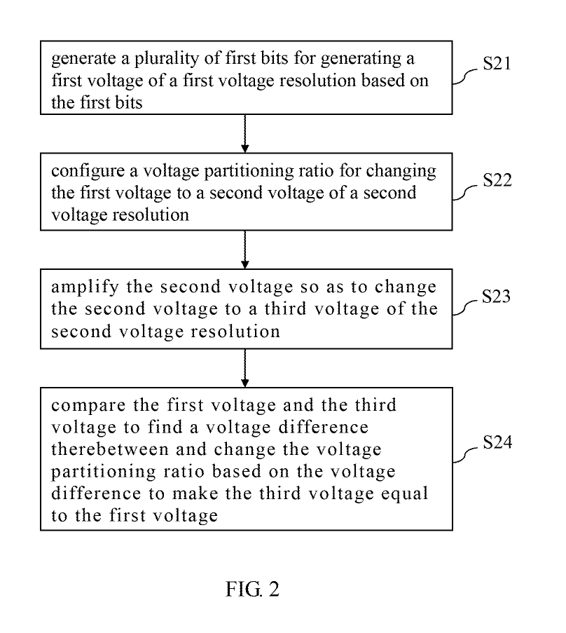

Referring to FIG. 2, there is shown a flow chart of a voltage resolution adjustment method according to an embodiment of the present invention. As shown in FIG. 2, the voltage resolution adjustment method starts with step S21 that involves generating a plurality of first bits for a first voltage having a first voltage resolution.

Step S22 involves configuring a voltage partitioning ratio whereby the first voltage is transformed to a second voltage having a second voltage resolution. The voltage partitioning ratio further comprises a constant voltage partitioning ratio and an adjustable voltage partitioning ratio. The constant voltage partitioning ratio is configured according to a proportion between impedance values. The second voltage resolution depends on the impedance values. The ratio of the first voltage to the second voltage is determined according to the constant voltage partitioning ratio and the adjustable voltage partitioning ratio.

Step S23 involves amplifying the second voltage to thereby generate a third voltage of the second voltage resolution.

Step S24 involves comparing the first voltage and the third voltage to find a voltage difference therebetween, and then changing the voltage partitioning ratio according to the voltage difference to make the third voltage equal to the first voltage.

Accordingly, a voltage resolution adjustment system and method of the present invention, when coupled with a system based on a combination of software and hardware, increase a low voltage resolution of an output voltage characterized by a low voltage resolution and generated by hardware (such as a chip of a digital-to-analog converter (DAC)) to a high voltage resolution. Hence, the voltage resolution adjustment system and method of the present invention are effective in producing a voltage output system of a high voltage resolution with cheap hardware of low voltage resolution. The system not only cuts hardware-based production costs, but also generates an output voltage of a specific high voltage resolution (such as 0.1 mV) precisely and in real time.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A voltage resolution adjustment system for increasing a voltage resolution of a first voltage from a first voltage resolution to a second voltage resolution, the first voltage resolution correlating with a quantity of a plurality of first bits, the voltage resolution adjustment system comprising:
a processing module for receiving the first bits and outputting the first voltage and a control signal based on the first bits;
a voltage-dividing module having a voltage input end and a voltage output end, connected to the processing module via the voltage input end, and adapted to configure a voltage partitioning ratio between the voltage output end and the voltage input end, thereby changing the first voltage to a second voltage of a second voltage resolution, wherein the voltage partitioning ratio varies with a voltage level of the control signal; and
an amplifying unit having an amplification input end and an amplification output end, connected to an output end of the voltage-dividing module via the amplification input end, connected to the processing module via the amplification output end, and characterized by a voltage amplification ratio between the amplification output end and the amplification input end, so as to increase the second voltage to a third voltage by amplification,
wherein, given a voltage difference between the third voltage and the first voltage, the processing module sends the control signal having a voltage value for adjusting the voltage partitioning ratio and thereby making the third voltage equal to the first voltage,
wherein the third voltage has the second voltage resolution.

2. The voltage resolution adjustment system of claim 1, wherein the processing module comprises a control unit, a first input unit, a second input unit, a first output unit, and a second output unit, the control unit being connected to the first input unit, the second input unit, the first output unit, and the second output unit, the first input unit receiving the first bits, the control unit converting the first bits to the first voltage, the first output unit outputting the first voltage, the second input unit receiving the third voltage, and the control unit sending the control signal from the second output unit based on the voltage difference between the first voltage and the third voltage.

3. The voltage resolution adjustment system of claim 1, wherein the voltage-dividing module comprises an invariable voltage-dividing unit and an adjustable voltage-dividing unit.

4. The voltage resolution adjustment system of claim 3, wherein the invariable voltage-dividing unit and the adjustable voltage-dividing unit are connected in series.

5. The voltage resolution adjustment system of claim 4, wherein the invariable voltage-dividing unit comprises fixed resistors, and the adjustable voltage-dividing unit comprises variable resistors.

6. The voltage resolution adjustment system of claim 1, wherein the second voltage resolution correlates with a quantity of a plurality of second bits, and the second bits outnumber the first bits.

7. The voltage resolution adjustment system of claim 1, wherein the processing module and the voltage-dividing module each have an inter-integrated circuit bus, such that the processing module and the voltage-dividing module transmit the control signal via the inter-integrated circuit bus.

8. A voltage resolution adjustment method, comprising the steps of:
(a) generating a plurality of first bits for generating a first voltage of a first voltage resolution;
(b) configuring a voltage partitioning ratio for changing the first voltage to a second voltage of a second voltage resolution;
(c) amplifying the second voltage so as to change the second voltage to a third voltage of the second voltage resolution; and
(d) comparing the first voltage and the third voltage to find a voltage difference therebetween and changing the voltage partitioning ratio based on the voltage difference to make the third voltage equal to the first voltage.

9. The voltage resolution adjustment method of claim 8, wherein the voltage partitioning ratio further comprises a constant voltage partitioning ratio and an adjustable voltage partitioning ratio, the constant voltage partitioning ratio being configured according to a proportion between impedance values, the second voltage resolution depending on the impedance values, wherein a ratio of the first voltage to the second voltage is determined according to the constant voltage partitioning ratio and the adjustable voltage partitioning ratio.
